(19) United States
(12) Patent Application Publication
(10) Pub. No.: US 2002/0062681 A1
(43) Pub. Date: May 30, 2002

(54) Oxygen sensor and flow meter device

(76) Inventor: Richard A. Livingston, Webster Groves, MD (US)

Correspondence Address: Daniel A. Crowe, BRYAN CAVE LLP, One Metropolitan Square, 211 N. Broadway, Ste.3600, St.Louis, MO, 63102-2750, US

(21) Appl. No.: 09/728,835

(22) Filed: Nov. 30, 2000

(51) Int. Cl. G01N 29/02

(52) U.S. Cl. 73/24.01

(57) ABSTRACT

A device that measures the concentration of a particular gas within a sample of gas includes a housing having a gas flow path with a gas inlet port designed to receive the sample of gas, a gas outlet port, and a chamber extending between the gas inlet and outlet ports. The sample of gas flows into the inlet port, proceeds through the chamber and exits the housing through the outlet port. The device further includes a first ultrasonic transmitter positioned within the chamber near the inlet port capable of transmitting an ultrasonic pulse into the chamber in a direction with the flow of gas, and a second ultrasonic transmitter positioned within the chamber near the outlet port capable of transmitting an ultrasonic pulse into the chamber in a direction against the flow of gas. An ultrasonic receiver is positioned within the chamber at or near the center of the gas flow path between the inlet and outlet ports, and is capable of receiving ultrasonic pulses transmitted by the first and second ultrasonic transmitters. The receiver produces a receive signal that represents of the concentration of the sample of gas passing through the chamber. Electronic circuitry including a microcontroller is coupled to the first and second ultrasonic transmitters to alternately initiate the transmission of an ultrasonic pulse from the first and second ultrasonic transmitters. The microcontroller is also coupled to the ultrasonic receiver to receive the transmit receive signal. The microcontroller compares the difference in time between the transmission of the ultrasonic pulse from the ultrasonic transmitters and the receipt of the corresponding receive signal to indicate the concentration of gas flowing through the measurement device.

### FIELD OF THE INVENTION

The present invention relates generally to devices and methods used to measure the concentration of oxygen in a sample of gas.

### BACKGROUND OF THE INVENTION

Systems that measure the oxygen concentration in air have many applications, including use in oxygen concentrators that provide oxygen enriched air to patients with reduced respiratory function. These systems are used to verify that the oxygen concentrators operate properly, i.e., to verify that the air delivered to the patient contains at least about 85-95% oxygen, as compared with a concentration of 21% oxygen in ordinary air.

Many existing methods for measuring oxygen concentration rely on ultrasonic techniques to measure the speed of sound traveling through the oxygen concentrators. One example is described in two patents issued to Aylsworth (U.S. Pat. Nos. 5,060,506 and 5,060,514), the contents of which are incorporated herein for all purposes. These patents describe an ultrasonic device that measures the oxygen concentration in air by measuring the speed of sound and the temperature of the gas to infer the oxygen concentration. The Aylsworth device has two transducers, one a transmitter initiating a 40 KHz sound signal and the other a receiver that detects the sound signal. Associated circuitry compares the phase of the detected sound wave with the phase of the emitted sound signal. The phase shift between these two signals is a function of the speed of the sound traveling through the device, which in turn is a function of the temperature and composition of the gas between the two transducers. The Aylsworth patents further describe circuitry that converts this phase difference into a voltage that can be calibrated, corrected for temperature, and interpreted as an oxygen concentration.

These patents describe oxygen sensors, but do not describe sensors that also measure flow. An ultrasonic flow speed measurement device is described in Frola et al. U.S. Pat. No. 5,247,826, the contents of which are incorporated herein for all purposes. In the Frola device, a sound signal is transmitted in one direction through a coiled tube, and then transmitted in the opposite direction. If the gas in the tube were stagnant, the speed of sound in both directions would be the same. If the gas is flowing, the speed of sound in each direction will be increased or decreased proportionally to the speed of the moving gas. By comparing the difference in speed in the two directions, the flow speed can be directly measured. By then calculating the average speed over time, the composition of the gas can be inferred as in the methods described in the Alysworth patents.

Stern U.S. Pat. No. 6,627,323 describes a device similar to the device described in the Alysworth patents, except that a microprocessor is used to generate the transmitted sound signal, to compare the phases of the transmitted and received signals, and to calculate the temperature-corrected oxygen concentration. In addition, this design uses two bi-directional transducers and a switching network to alternately connect one transducer to the transmit circuitry and the other transducer to the receive circuitry, and vice-versa for measuring the speed of sound in the opposite direction. In this way, only one set of transmit/receive circuits are required. Thus, in addition to oxygen concentration, this device measures the speed of flow by calculating the difference in the speed of sound propagating with the flow of gas and the speed of sound propagating against the flow of gas.

These prior art systems incorporate analog circuitry or a microprocessor for computing speed of the sound waves. Each of these prior art solutions incorporates expensive transducers capable of both transmitting and receiving ultrasonic signals. The need remains for an improved oxygen sensor with a gas measurement device. Preferably, such an improved system would incorporate a dedicated high frequency time interval counter to digitally measure the phase between the transmit and receive waveforms, without requiring an expensive high speed microprocessor. The preferred system would also eliminate the need to use expensive bi-directional transducers.

### SUMMARY OF THE INVENTION

A device for measuring the oxygen concentration in a sample of gas and to measure the flow rate of gas having these features and satisfying these needs has now been developed. The current invention optimizes prior art devices and methods for lower cost and better resolution of the oxygen and flow measurements. The gas measurement device of the present invention relies on the well-known principles that different gases propagate sound waves at different velocities.

The present invention uses two dedicated transmit transducers (which are generally about one-half the cost of a bi-directional transducer) and a dedicated receive transducer. The use of a third ultrasonic transducer allows a significant simplification and reduction in cost of the circuitry involved. The arrangement eliminates the need for a switching network to connect one transmitter circuit to either of the transducers, and one receive circuit to the other transducer. In addition, the present invention includes an improved phase measurement circuit that improves the accuracy and resolution of the measurements.

The gas measurement device of the present invention measures the concentration of a particular gas within a sample of gas that includes the particular gas and includes a housing having a gas flow path with a gas inlet port designed to receive the sample of gas, a gas outlet port, and a chamber extending between the gas inlet and outlet ports. The sample of gas flows into the inlet port, proceeds through the chamber and exits the housing through the outlet port. The device further includes a first ultrasonic transmitter positioned within the chamber near the inlet port capable of transmitting an ultrasonic pulse into the chamber in a direction with the flow of gas, and a second ultrasonic transmitter positioned within the chamber near the outlet port capable of transmitting an ultrasonic pulse into the chamber in a direction against the flow of gas. An ultrasonic receiver is positioned within the chamber at or near the center of the gas flow path between the inlet and outlet ports, and is capable of receiving ultrasonic pulses transmitted by the first and second ultrasonic transmitters. The receiver produces a receive signal whose phase represents the speed of sound and therefore the composition of the sample of gas passing through the chamber. Electronic circuitry including a microcontroller is coupled to the first and second ultrasonic transmitters to alternately initiate the transmission of an ultrasonic pulse from the first and second ultrasonic transmitters. The microcontroller is also coupled to the ultrasonic receiver to receive the transmit receive signal. The microcontroller compares the difference in time between the transmission of the ultrasonic pulse from the ultrasonic transmitters and the receipt of the corresponding receive signal to indicate the concentration of gas flowing through the measurement device. The ultrasonic transmitters and receiver may be mounted directly onto a printed circuit board and within a housing wherein the chamber extending between the gas inlet and outlet ports is folded to reduce the overall size of the housing. The gas measurement device may also include a hardware counter driven by a high speed oscillator to determine the amount of time between the transmission of an ultrasonic pulse from one of the transmitters and the receipt of the ultrasonic pulse by the receiver.

The gas measurement device, or any similar device, may be used in a method for measuring the concentration and flow rate of a particular gas within a sample of gas that includes the particular gas as the sample of gas flows. Such a method may include transmitting a first ultrasonic signal from a first ultrasonic transmitter in a direction of the flow of gas from an initial transmission point, transmitting a second ultrasonic signal from a second ultrasonic transmitter in a direction against the flow of gas from a second transmission point, in which both ultrasonic signals are controlled with a microcontroller. The first and second ultrasonic signals may be received at a receiving point using an ultrasonic receiver positioned approximately equidistant from the first and second transmission points. The temperature of the sample of gas and the change in the time of travel for the first and second ultrasonic signals to arrive at the receiving point may then be measured to provide a measure of the concentration of the particular gas within the sample of gas and the flow rate of the sample of gas.

### BRIEF DESCRIPTION OF THE DRAWINGS

These and other features and advantages of the present invention will become better understood with regard to the following description, appended claims, and accompanying drawings wherein:

FIG. 1 illustrates the gas measurement device of the present invention;

FIG. 2 illustrates an alternative arrangement of the acoustical housing of the present invention;

FIG. 3 illustrates a third embodiment of the acoustical housing of the gas measurement device having a folded gas flow path;

FIGS. 4a and 4b illustrate a fourth embodiment of the acoustical housing of the gas measurement device;

FIG. 5 illustrates a portion of the electronic circuitry capable of controlling the ultrasonic transducers included in the present gas measurement device;

FIG. 6 illustrates one embodiment of the circuitry coupled to the ultrasonic receiver of the present invention;

FIG. 7 illustrates an alternative arrangement for measuring the time of travel of the ultrasonic signals generated by the ultrasonic transducers; and

FIG. 8 illustrates an oxygen concentrator incorporating the gas measurement device of the present invention.

These drawings are provided for illustrative purposes only and should not be used to unduly limit the scope of the present invention.

### DETAILED DESCRIPTION OF THE INVENTION

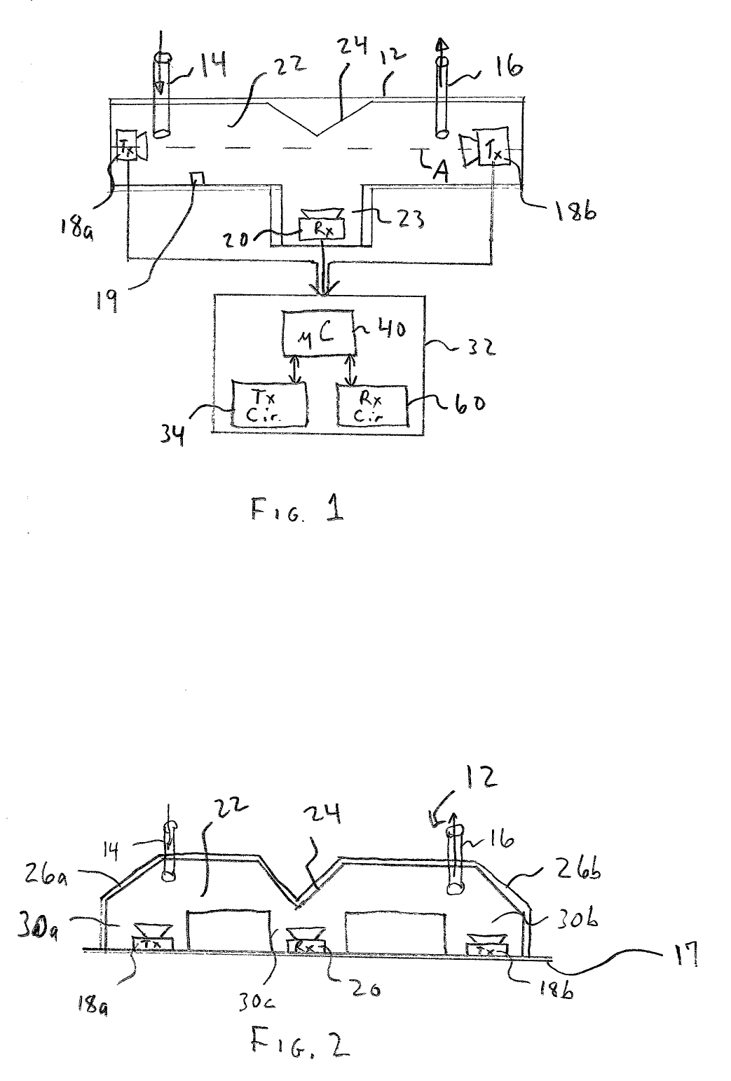

FIG. 1 illustrates an embodiment the gas measurement device 10 of the present invention showing three ultrasonic transducers positioned within an acoustical housing 12. The acoustical housing 12 includes a generally cylindrical and hollow acoustical pipe 22 constructed of a plastic material or any other suitable material that allows for the passage of a sample of gas therethrough and for the propagation of ultrasonic waves through the sample of gas. The sample of gas analyzed with the gas measurement device 10 may be oxygen in air, water in air, oxygen in hydrogen, or fuel vapors in air. In one particular application, the sample of gas is concentrated oxygen produced by an oxygen concentrator for use with patients with respiratory disorders and the gas measurement device 10 analyzes the sample of gas to ensure that the concentrated oxygen content of such sample exceeds a predefined threshold, for example, 85% oxygen.

The acoustical housing 12 includes a gas inlet port 14 in fluid communication with the interior of the acoustical pipe 22 to allow a sample gas to be injected through the inlet port 14 and to flow into the interior of the hollow acoustical pipe 22. The gas injected into the inlet port 14 may be output from a gas concentration assembly. As an example, the gas measurement device 10 may be incorporated into a oxygen concentrator, such that the gas produced by the concentrator flows through the gas measurement device 10 to allow the sample of gas to be properly analyzed before it is delivered to the patient. A gas outlet port 16 is included in the housing 12 at the other end of the housing 12 and is also in fluid communication with the interior of the acoustical pipe 22. In the arrangement depicted in FIG. 1, the gas flow is straight through the tube from the inlet port 14 to the outlet port 16. The gas under test is injected through the inlet port 14, flows through the interior of the acoustical pipe 22, and exits via the gas outlet port 16.

The gas measurement device 10 includes two ultrasonic transmitters 18a, 18b, capable of emitting an ultrasonic signal that resonates at, for example, about 40 KHz, or any other frequency adjusted to the length of the acoustical pipe 22 that permits its phase to be measured. As those skilled in the art will appreciate, the frequency of the emitted ultrasonic signal must be tailored to the length of the acoustical pipe 22 to avoid period error. The ultrasonic transmitters 18a, 18b are positioned at respective ends of the acoustical pipe 22 such that the signal emitted will generally be directed toward the interior and middle of the housing 12 and parallel with the flow of gas as shown by dashed line A in FIG. 1. Thus, ultrasonic transmitter 18a emits its ultrasonic signal in a direction with the flow of gas, and the second ultrasonic transmitter 18b emits its signal in a direction against the flow of gas. Preferably, in the embodiment illustrated in FIG. 1, the transmitters 18a, 18b are snugly fit into the ends of the acoustical housing 12 to seal the housing 12 and generally prevent the emission of sonic signals from the housing 12. An acceptable transmitter is model MA4054S, manufactured by Murata Electronics.

The measurement device 10 further includes an ultrasonic receiver 20 positioned near the middle of the acoustical pipe 22 to receive the signals emitted by the transmitters 18a, 18b. The receiver 20 may be stationed within a short piece of hollow tubing 23 that is in fluid communication with the interior of the acoustical pipe 22 of the acoustical housing 12, as shown in FIG. 1. In this embodiment, the hollow tubing 23 is arranged at a perpendicular to the gas flow path through the acoustical pipe 22. The ultrasonic receiver 20 is preferably positioned within the acoustical housing 12 at or near the center of the gas flow path between the inlet port 14 and outlet port 16 such that the receiver 20 receives ultrasonic pulses transmitted by the ultrasonic transmitters 18a, 18b. The ultrasonic receiver is preferably capable of receiving the ultrasonic signals in the range emitted by the transmitters 18a, 18b, e.g., in the range of 40 KHz. An acceptable receiver is model MA4054R, manufactured by Murata Electronics.

The acoustical housing 12 may include an acoustical reflector 24 positioned near the receiver 20 to deflect at least some of the sonic waves emitted from the two transmitters 18a, 18b in a direction toward the ultrasonic receiver 20. The reflector 24 may be, for example, a triangular-shaped plastic or metal component that extends partially in the interior of the acoustical pipe 22 of the housing 12. Alternatively, the reflector 24 may be an integrally molded component of the housing 12. The reflector 24 preferably reflects some of the sound waves into the hollow tubing 23, but allows the gas flowing through the housing 12 to flow past the reflector 24 and on toward the outlet port 16. Although a single acoustical reflector 24 is illustrated in the embodiment disclosed in FIG. 1, two or more reflectors may be incorporated and designed to deflect the sonic wave emitted from the transmitters 18a, 18b toward the single ultrasonic receiver 20. The device 10 preferably also includes a temperature sensor 19, which measures the temperature of the gas flowing through the chamber 22 and assists in calculating the flow rate of the gas and compensating the gas concentration measurement.

Each of the three ultrasonic transducers are electronically coupled to measurement electronics 32 including a microcontroller 40 to analyze the sample of gas flowing though the gas measurement device 10. As discussed in more detail below, the measurement electronics 32 further includes transmit circuitry 34 and receive circuitry 60.

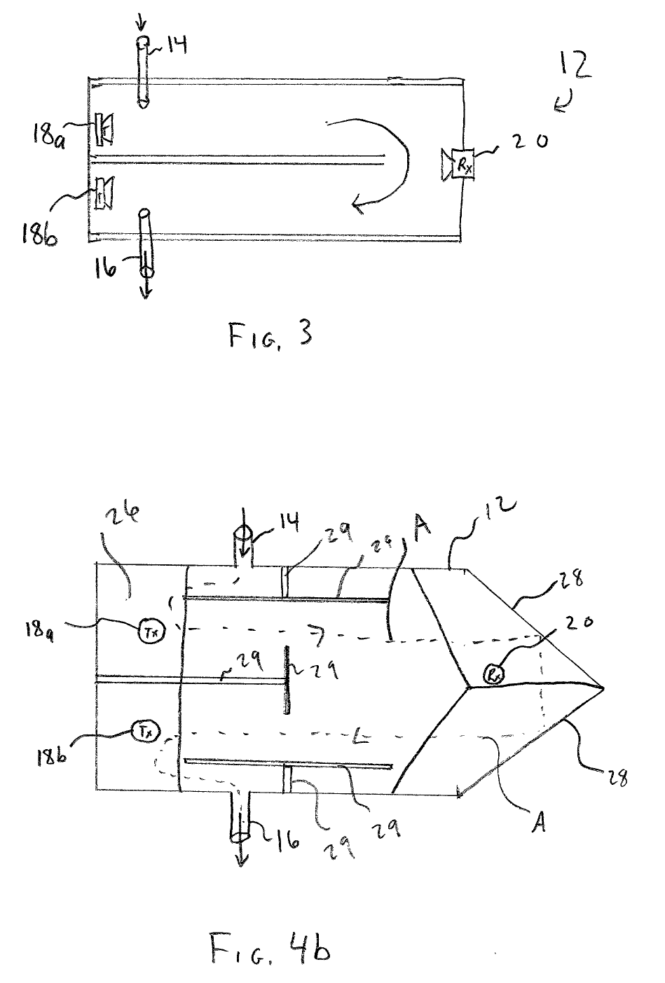

FIG. 2 illustrates another embodiment of the housing 12, which includes an acoustical pipe 22 having three branch tubes 30a, 30b, and 30c. The outer branch tubes 30a, 30b each contain one of the ultrasonic transmitters 18a, 18b. The center branch tube 30c houses the ultrasonic receiver 20. Each of the branch tubes 30a, 30b, and 30c are arranged perpendicular to the remainder of the acoustical pipe 22 and are in fluid communication with the interior of the acoustical pipe 22. In this embodiment, the ultrasonic transmitters 18a, 18b are not directly oriented to emit their sound waves toward the ultrasonic receiver 20, but rather are aligned along an axis perpendicular to the flow of gas and oriented such that their ultrasonic signals are originally emitted at a perpendicular with respect to the gas flow (labeled as A). The acoustical pipe 22, therefore, includes acoustical reflectors 26a, 26b that deflect the sound waves generally in the direction along the center axis of the acoustical pipe 22 and toward the acoustical reflector 24 adjacent the ultrasonic receiver 20. This acoustical reflector 24 then directs the sound waves toward the ultrasonic receiver 20. Gas inlet and outlet ports 14 and 16 are included to receive and emit the sample of gas under test. In the configuration illustrated in FIG. 2, the transmitters 18a, 18b, and receiver 20 are all mounted directly onto a printed circuit board 17 beneath the housing 12.

FIG. 3 illustrates another embodiment of the acoustical housing 12 for the gas measurement device 10. In this embodiment, the gas flow path is folded to reduce the overall length of the housing 12. In this embodiment, an ultrasonic transmitter 18a, 18b is positioned at each end of the acoustical pipe 22 and oriented to emit their sound waves directly into the interior of the acoustical pipe 22 generally along its central axis. The ultrasonic receiver 20 is preferably stationed at or near the bend in the acoustical pipe 22 to receive ultrasonic signals from both the transmitters 18a, 18b. Gas inlet and outlet ports 14 and 16 are include to receive the emit the sample of gas under test. The embodiment illustrated in FIG. 3 eliminates the need for ultrasonic deflectors in the housing 12.

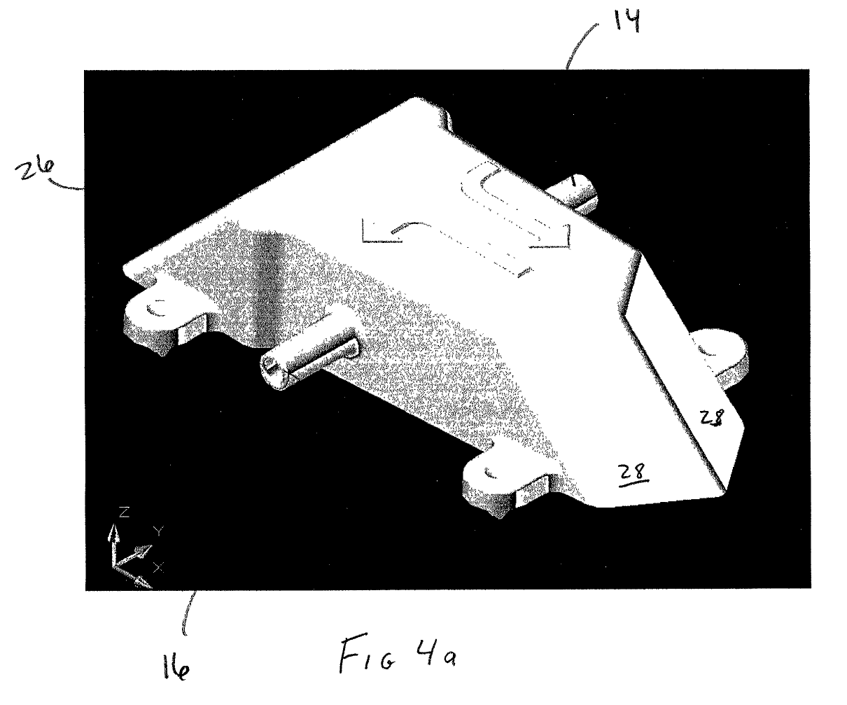

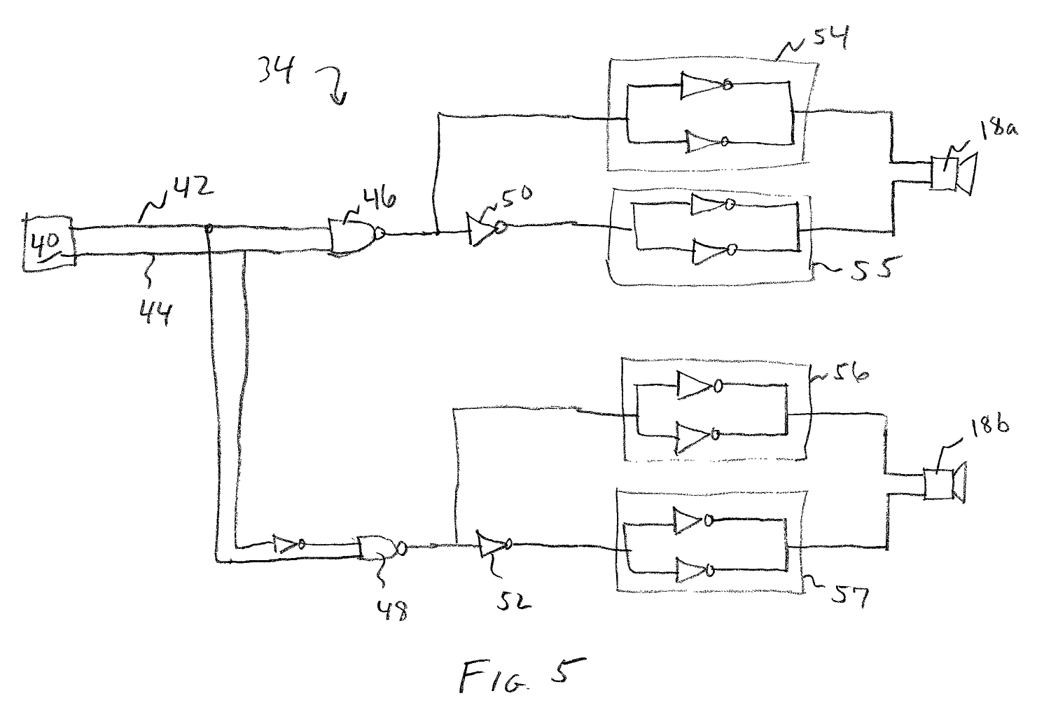

FIG. 4a and 4b show another embodiment of the gas measurement device 10 having a folded gas flow path. This embodiment incorporates a generally pyramid shaped housing 12 adapted to create a relatively long gas flow path within a relatively confined space. In this embodiment, the gas under test flows into the gas inlet port 14, reflects off an angled portion of the housing 12 forming a rear acoustical reflector 26, travels in the direction depicted by dashed line A, reflects twice off of another angled portion of the housing forming a front acoustical reflector 28, proceeds back toward and again reflects off of the rear acoustical deflector 26 and proceeds out through the gas outlet port 16. The gas traveling through the housing 12 is assisted in its proper flow path by a number of gas path separators 29. The housing 12, including the gas inlet and outlet ports 14 and 16, the rear and forward acoustical reflectors, 26 and 28, and the gas path separators 29 may all be integrally formed from a suitable hard surface material such as a variety of plastics, metals, ceramics, or any other solid, stiff substance. Two ultrasonic transmitters 18a, 18b are positioned to emit their signals at a right angle with respect to the central axis of the gas flow path. The ultrasonic receiver 20 is again positioned at or near the center of the gas flow path to receive signals from the transmitters 18a, 18b.

In this configuration, the housing 12 is designed to permit the transducers to be mounted directly to a printed circuit board, thus reducing hand assembly operations. The housing 12 can maintain calibration better due to the incorporation of a PCB board with the plastic housing 12, thus improving the dimensional stability between the transmitting and receiving transducers. The housing 12, acoustical guide tubes 26a and 26b, and gas inlet and outlet ports 14 and 16 may be integrally formed from a variety of plastics, metals, ceramics, or any other solid, stiff substance.

FIG. 5 illustrates a portion of the microcontroller-based transmit circuitry 34 that is included in the measurement electronics 32 that control the ultrasonic transmitters 18a, 18b. The microcontroller 40 drives the transmit signal 42 to allow the transmitters 18a, 18b to resonate at a particular frequency, e.g., about 40 KHz. Only one transmitter is transmitting at a given time, which is dictated by the transmitter select line 44. Transmitter 18a is selected to emit when the transmitter select line 44 is driven high. Both the transmitter select line 44 and the transmit signal 42 are fed into NAND gate 46 and the resulting signal is fed into transmit driver 54, through a capacitor C2 and into one input of the transmitter 18a. The output of NAND gate 46 is also fed through an inverter 50 and then into transmit driver 55 and into the second input of the transmitter 18a. The transmitter 18a will emit a signal when both of its inputs are active.

Transmitter 18b is controlled in a similar fashion. The transmitter select line 44 is inverted and fed into a NAND gate 48 along with the transmit signal 42. The output of NAND gate 48 is fed into transmit driver 56, through a capacitor C1 and into one input of the transmitter 18b. The output of NAND gate 48 is also fed through an inverter 52, through transmit driver 57, and into the second input of the transmitter 18b. The transmitter 18b will emit a signal when both of its inputs are active. Thus, the circuit illustrated in FIG. 5 operates to alternatively drive each of the ultrasonic transmitters 18a, 18b, at a particular frequency.

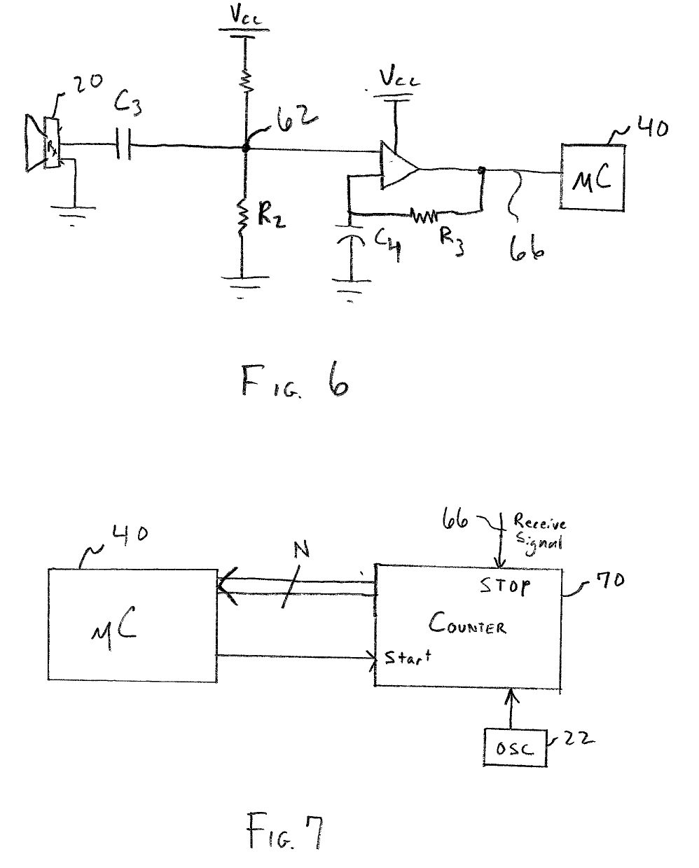

FIG. 6 illustrates one embodiment of the receive circuitry 60 coupled to the ultrasonic receiver 20. The output of the receiver 20 is fed through capacitor C3 and into a node 62 that is also coupled to a high voltage signal, Vcc (through resistor R1). The node 62 is also coupled to a ground reference through resistor R2. The node 62 is further coupled to the non-inverting input of transistor 64, which has its inverting terminal coupled to the ground reference through capacitor C4. A feedback loop, coupling the output of the transistor 64 to the inverting input through resistor R3, is also included.

The output of the receive circuitry 60 coupled to the ultrasonic receiver 20, defined as the receiver output signal 66, is coupled to the microcontroller 40 and may be used to determine the amount of time an ultrasonic pulse takes to travel through the gas measurement device 10, thus providing an indication of the concentration of the gas passing through the measurement device 10. Thus, the microcontroller 40 may measure the amount of time from the emission of an ultrasonic signal from one of the transmitters 18a, 18b, to receipt of the signal.

FIG. 7 illustrates an alternative arrangement in which the receiver output signal 66 is coupled to the “stop” input an a conventional 8-bit (or more) hardware counter 70. The “start” input is coupled to the microcontroller 40. The hardware counter 70 is driven by a high speed oscillator 72, which cycles at, for example 20 MHz. When the microcontroller 40 directs the drive circuitry to emit an ultrasonic signal, the microcontroller 40 initiates the hardware counter 70. The hardware counter 70 then counts until the receiver output signal 66 indicates receipt of the corresponding sonic signal. A number of data lines (N) extend from the hardware counter 70 to the microcontroller 40 and provide the number of counts (i.e., time) to the microcontroller 40. The time the ultrasonic signal takes to travel through the housing is dependent on the length of the housing, by the composition of the gas, by the temperature of the gas and by the flow rate of the gas. This high frequency time interval circuit improves the accuracy of the oxygen and flow speed calculations, without requiring a high speed microprocessor, and improves the time resolution.

Flow rate may be determined by comparing the difference in the time of travel of an ultrasonic signal emitted in the direction of the gas flow and one emitted in the opposite direction. Thus, flow rate may be determined according to the formula:

Q=abs(C₁(t₁₈ₐ−t_{18b}))+C₂O₁,

where C₁ and C₂ are constants for the particular gas measurement device 10, O₁ is an offset value that may be determined during calibration of the device 10, and t₁₈ₐ and t_{18b} are the times of travel for an ultrasonic pulse emitted from transmitter 18a and transmitter 18b respectively to reach receiver 20. The microcontroller 40 may compute the concentration of a particular gas within a sample of gas flowing through the gas measurement device 10 according to the formula:

P=C₃T+C₄O₂+C₅(t₁₈ₐ+t_{18b}),

where C₃, C₄, and C₅ are constants for the particular gas measurement device 10, T is the temperature as determined from temperature sensor 19, O₂ is an offset value that may be determined during calibration of the device 10, and t₁₈ₐ and t_{18b} are the times of travel for an ultrasonic pulse emitted from transmitter 18a and transmitter 18b respectively to reach receiver 20.

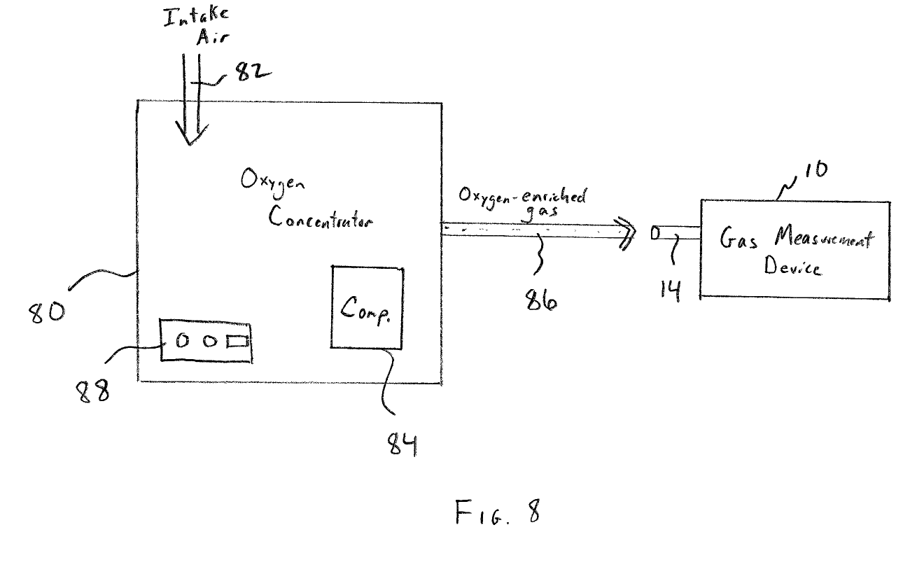

FIG. 8 illustrates the use of the gas measurement device 10 as part of, or in conjunction with, a conventional oxygen concentrator 80, to continuously or intermittently monitor and report the concentration or purity of the oxygen-enriched gas produced by the oxygen concentrator 80. The oxygen concentrator includes an air inlet valve 82, which accepts air, a compressor 84 for producing concentrated oxygen and an supply valve 86, through which the concentrated oxygen is delivered to the patient. The oxygen concentrator 80 also includes the gas measurement device 10, which may be any of the embodiments described above. The oxygen concentrator 80 may also include audible alarms or visual indicators 88 that provide a signal to the user of the oxygen concentrator of certain failure conditions, including too low a level of concentrated oxygen, low pressure, power failure, compressor shutdown, high temperature, etc.

It should be understood that the oxygen sensor of the present invention may be used to measure oxygen concentrations in oxygen enriched air for hospital, subacute, and home care patients. The invention may also be used in any application where one component of a gas mixture is desired to be measured and all other components are stable, including applications used with compressed gasses and applications in the medicine, aviation, and power generation.

Although the present invention has been described in considerable detail with reference to certain presently preferred embodiments thereof, other embodiments are possible without departing from the spirit and scope of the present invention. Therefore the appended claims should not be limited to the description of the preferred versions contained herein.

I claim:

1. A device for measuring the concentration of a particular gas within a sample of gas that includes the particular gas and the flow rate of the sample of gas comprising:
a housing having a gas flow path and comprising a gas inlet port designed to receive the sample of gas, a gas outlet port, and a chamber extending between the gas inlet and outlet ports, wherein the sample of gas flows into the inlet port, proceeds through the chamber and exits the housing through the outlet port;
a first ultrasonic transmitter positioned within the chamber near the inlet port capable of transmitting an ultrasonic pulse into the chamber in a direction with the flow of gas;
a second ultrasonic transmitter positioned within the chamber near the outlet port capable of transmitting an ultrasonic pulse into the chamber in a direction against the flow of gas;
an ultrasonic receiver positioned within the chamber at or near the center of the gas flow path between the inlet and outlet ports, the receiver capable of receiving ultrasonic pulses transmitted by the first and second ultrasonic transmitters and producing a receive signal representative of the concentration of the sample of gas passing through the chamber;
a temperature sensor positioned within the chamber providing a measurement of the temperature of the sample of gas; and
electronic circuitry including a microcontroller coupled to the first and second ultrasonic transmitters to alternately initiate the transmission of an ultrasonic pulse from the first and second ultrasonic transmitters, to the ultrasonic receiver to receive the receive signal, and to the temperature sensor to receive the temperature measurement;
wherein the microcontroller compares the difference in time between the transmission of the ultrasonic pulse from the ultrasonic transmitters and the receipt of the corresponding receive signal and calculates the concentration of gas flowing through the measurement device and the flow rate of the sample of gas, wherein concentration of gas measurement is compensated by the temperature measurement.

2. The device of claim 1 wherein the chamber extending between the gas inlet and outlet ports is folded to reduce the overall size of the housing.

3. The device of claim 1 wherein the housing further comprises acoustical reflectors to direct the ultrasonic pulses from each of the two transmitters to the receiver.

4. The device of claim 1 wherein the ultrasonic transmitters are oriented to emit their signals at an angle perpendicular to the flow of gas, the device further comprising reflectors that reflect the ultrasonic signals in a direction generally parallel to the flow of gas and toward the ultrasonic receiver.

5. The device of claim 4 further comprising one or more reflectors designed to reflect the parallel ultrasonic signals perpendicular to the flow of gas and toward the ultrasonic receiver.

6. The device of claim 1 further comprising a hardware counter driven by a high speed oscillator to determine the amount of time between the transmission of an ultrasonic pulse from one of the transmitters and the receipt of the ultrasonic pulse by the receiver.

7. The device of claim 1 wherein the ultrasonic transmitters and receiver are mounted onto a printed circuit board.

8. The device of claim 1 wherein the particular gas is oxygen.

9. An oxygen concentrator comprising:
an air inlet valve designed to receive intake air having a lower concentration of oxygen;
a concentration assembly for producing oxygen-enriched air from the intake air; and
a measurement device for measuring the concentration of oxygen in the oxygen-enriched air and its flow rate comprising:
a housing having a gas flow path comprising a gas inlet port designed to receive a sample of the oxygen-enriched gas, a gas outlet port, and a chamber extending between the gas inlet and outlet ports, wherein the sample of gas flows into the inlet port, proceeds through the chamber and exits the housing through the outlet port;
a first ultrasonic transmitter positioned within the chamber near the inlet port capable of transmitting an ultrasonic pulse into the chamber in a direction with the flow of gas;
a second ultrasonic transmitter positioned within the chamber near the outlet port capable of transmitting an ultrasonic pulse into the chamber in a direction against the flow of gas;
an ultrasonic receiver positioned within the chamber at or near the center of the gas flow path between the inlet and outlet ports, the receiver capable of receiving ultrasonic pulses transmitted by the first and second ultrasonic transmitters and producing a receive signal;
a temperature sensor positioned within the chamber providing a measurement of the temperature of the sample of gas; and
a microcontroller coupled to the first and second ultrasonic transmitters to alternately initiate the transmission of an ultrasonic pulse from the first and second ultrasonic transmitters, to the ultrasonic receiver to receive the transmit receive signal, and to the temperature sensor to receive the temperature measurement;
wherein the microcontroller compares the difference in time between the transmission of the ultrasonic pulse from the ultrasonic transmitters and the receipt of the corresponding receive signal and calculates the concentration of gas flowing through the measurement device and the flow rate of the oxygen-enriched air, wherein concentration measurement is compensated by the temperature measurement.

10. The device of claim 9 wherein the chamber extending between the gas inlet and outlet ports is folded to reduce the overall size of the housing.

11. The device of claim 9 wherein the housing further comprises acoustical reflectors to direct the ultrasonic pulses from each of the two transmitters to the receiver.

12. The device of claim 9 wherein the ultrasonic transmitters are oriented to emit their signals at an angle perpendicular to the flow of gas, the device further comprising reflectors that reflect the ultrasonic signals in a direction generally parallel to the flow of gas and toward the ultrasonic receiver.

13. The device of claim 12 further comprising one or more reflectors designed to reflect the parallel ultrasonic signals perpendicular to the flow of gas and toward the ultrasonic receiver.

14. The device of claim 9 further comprising a hardware counter driven by a high speed oscillator to determine the amount of time between the transmission of an ultrasonic pulse from one of the transmitters and the receipt of the ultrasonic pulse by the receiver.

15. The device of claim 9 wherein the ultrasonic transmitters and receiver are mounted onto a printed circuit board.

16. The device of claim 9 wherein the particular gas is oxygen.

17. The oxygen concentrator of claim 9 further comprising an indicator to notify a user if the concentration of oxygen in the oxygen-enriched air produced by the oxygen concentrator falls below a pre-defined level.

18. A method for measuring the concentration and flow rate of a particular gas within a sample of gas that includes the particular gas as the sample of gas flows, comprising the steps of:
transmitting a first ultrasonic signal from a first ultrasonic transmitter in a direction of the flow of gas from an initial transmission point;
transmitting a second ultrasonic signal from a second ultrasonic transmitter in a direction against the flow of gas from a second transmission point;
controlling the transmission of the first and second ultrasonic signals with a microcontroller;
detecting the first and second ultrasonic signals at a receiving point using an ultrasonic receiver positioned approximately equidistant from the first and second transmission points; and
measuring the temperature of the sample of gas and the change in the time of travel for the first and second ultrasonic signals to arrive at the receiving point to provide a measure of the concentration of the particular gas within the sample of gas and the flow rate of the sample of gas.
